(19) United States
(12) Patent Application Publication
(10) Pub. No.: US 2003/0138642 A1
(43) Pub. Date: Jul. 24, 2003

(54) Aqueous two-component polyurethane coating composition with improved adhesion and corrosion resistance

(76) Inventors: Burkhard Kohler, Leverkusen (DE); Joachim Probst, Leverkusen (DE); Michael Sonntag, Odenthal (DE)

Correspondence Address: Patent Department, Bayer Corporation, 100 Bayer Road, Pittsburgh, PA, 15205-9741, US

(21) Appl. No.: 09/562,632

(22) Filed: May 2, 2000

(30) Foreign Application Priority Data
May 7, 1999 (DE) 19921156.6

(51) Int. Cl. B32B 3/02

(52) U.S. Cl. 428/447; 106/702

(57) ABSTRACT

The present invention relates to a coating composition containing

a) 30 to 95 wt. % of an aqueous, hydroxy-functional resin dispersion,

b) 5 to 70 wt. % of a polyisocyanate component having a free isocyanate group content of 5 to 50 wt. % and a viscosity of 5 to 10,000 mPa.s (at 23° C. and D=40s⁻¹) and

c) 0.1 to 10 wt. % of a silane component of the general formula (I)

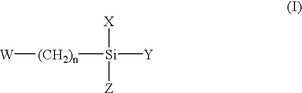

wherein

W represents the groups

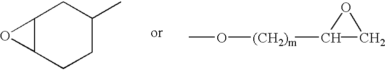

m is 1, 2, 3, or 4,

n is 2, 3 or 4, preferably 2 and 3, and

X, Y, Z represent, independently of one another, the same or different organic groups having 1 to 30 carbon atoms, provided that at least one of the groups represents an alkoxy group having 1 to 4 carbon atoms,

wherein the molar ratio of the hydroxyl groups of component a) to the isocyanate groups of component b) is between 0.2:1 and 3:1, and the sum of the wt. % of components a) to c) is 100, based on the total weight of a), b), and c).

The present invention further relates to the use of these coating compositions. for coating any substrates, preferably metallic substrates.

### BACKGROUND OF THE INVENTION

1. Field of the Invention

The present invention relates to aqueous two-component (2K) polyurethane (PU) coating compositions with improved adhesion and corrosion resistance, preferably on metal substrates, such as aluminum, galvanized steel and car body sheet, and a process for the production thereof.

2. Description of the Prior Art

Ecological matters play an important part in surface finishing technology. One particularly urgent problem in this area is the reduction of the quantities of organic solvents used for paints and coating compounds.

It is known from EP-A 0 358 979 that, when selected aqueous polyhydroxyl compounds based on vinyl polymers are reacted with organic polyisocyanates having free isocyanate groups, aqueous two-component polyurethane systems can be produced by emulsifying the polyisocyanates having free isocyanate groups in the aqueous polymer solution or dispersion. The polyhydroxyl compounds described in EP-A 0 358 979, for example, are radically polymerized by conventional polymerization processes, preferably in an organic solution, and then transferred into an aqueous solution of a neutralizing agent—usually ammonia or tertiary amines—and converted to an aqueous solution or dispersion. The organic solvent can remain in the aqueous medium or can be removed by distillation, as required.

Aqueous emulsion polymers produced by an emulsion polymerization process are also suitable for 2K PU technology (e.g. EP-A 496 210 and EP-A 557 844).

However, adhesion problems have been observed with these aqueous 2K PU systems after application on special substrate surfaces, especially untreated metal surfaces such as aluminium, galvanized steel and car body sheet (USt 1405 steel sheet). These can then lead to undesirable signs of corrosion.

It is known from EP-A 872 499 and EP-A 874 011 to modify aqueous 2K PU systems by adding silanes with isocyanate reactive groups (e.g. silanes with amino, mercapto or hydroxyl groups) or to react them with polyisocyanates to obtain aqueous 2K systems. Coatings having good water resistance under relatively mild conditions or coatings having high resistance to wear and abrasion (road markings) are obtained.

A detailed examination of these 2K PU systems, particularly on untreated metal surfaces as substrate (e.g. steel) showed that, under more severe conditions such as the condensation test according to DIN 50 017 and especially the salt spray test according to DIN 53 167, the resistance of the coatings is generally inadequate, even in the presence of these isocyanate reactive silanes. It was an object of the present invention to develop additives which pass these more severe tests.

Surprisingly, it has now been found that special silanes with epoxy groups, which do not react with isocyanate groups under conventional conditions, (at room temperature and in absence of catalysts for the formation of oxazolidinones) increase the adhesion and the corrosion resistance of such aqueous 2K PU systems to a very high level, especially on untreated metal surfaces, even in condensation and salt spray tests.

### SUMMARY OF THE INVENTION

The present invention relates to a coating composition containing

a) 30 to 95 wt. % of an aqueous, hydroxy-functional resin dispersion,

b) 5 to 70 wt. % of a polyisocyanate component having a free isocyanate group content of 5 to 50 wt. % and a viscosity of 5 to 10,000 mPa.s (at 23° C. and D=40 s⁻¹) and

c) 0.1 to 10 wt. % of a silane component of the general formula (I)

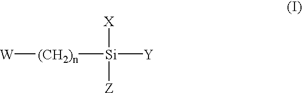

wherein

W represents the groups

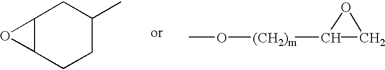

W is 1, 2, 3,or 4 and

n is 2, 3 or 4, preferably 2 and 3 and

X, Y, Z represent, independently of one another, the same or different organic groups having 1 to 30 carbon atoms, provided that at least one of the groups represents an alkoxy group having 1 to 4 carbon atoms,

wherein the molar ratio of the hydroxyl groups of component a) to the isocyanate groups of component b) is between 0.2:1 and 3:1, and the sum of the wt. % of components a) to c) is 100, based on the total weight of a), b), and c).

The present invention further relates to the use of these coating compositions for coating any substrates, preferably metallic substrates.

### DETAILED DESCRIPTION OF THE INVENTION

All resin dispersions conventionally used in aqueous 2K polyurethane coating technology can be used as component a). These resins and the processes for the production thereof are known from the literature. For example, the resins can be chosen from polyesters, vinyl polymers, polyurethanes, polyureas, polycarbonates or polyethers. The use of any hybrid dispersions or any mixtures of different dispersions is also possible. The resins are usually hydroxy-functional. However, in exceptional cases it is also possible to use non-functional dispersions as binder components in two-component polyurethane coatings.

Resin dispersions with hydroxyl values of 8 to 264 mg KOH/g resin solid and acid values of 3 to 100 mg KOH/g resin solid are preferred.

Hardener component b) is chosen from any organic polyisocyanates having aliphatically, cycloaliphatically, araliphatically and/or aromatically bound free isocyanate groups and an average NCO functionality of 2.0 to 5.0, preferably 2.2 to 4.0.

The use of polyisocyanate hardeners in aqueous 2K PU coating compositions without the addition of silane is known. For example, “laquer polyisocyanates” based on hexamethylene diisocyanate (HDI), 1-isocyanato-3,3,5-trimethyl-5-isocyanatomethylcyclohexane (IPDI) and/or bis(isocyanatocyclohexyl)methane or other aliphatic diisocyanates or mixtures of these diisocyanates are highly suitable. The term “laquer polyisocyanates” based on diisocyanates is intended to describe the known derivatives of these diisocyanates containing biuret, urethane, uretdione and/or isocyanurate groups, which, following their preparation, usually have been freed from excess monomeric diisocyanate by known methods, preferably by distillation, to a residual content of less than 0.5%. Processes for the production of these “lacquer polyisocyanates” are described, for example, in U.S. Pat. Nos. 3,124,605, 3,358,010, 3,903,126, 3,903,127, 3,976,622 or 4,324,879.

The use of aromatic polyisocyanates, e.g. “laquer polyisocyanates” based on 4,4′-diisocyanatodiphenylmethane or mixtures thereof with its isomers and/or higher homologs, is also possible. It is also possible to use any mixtures of the polyisocyanates mentioned.

To facilitate the incorporation of the hardeners, hydrophillically modified polyisocyanates may also be used in two-component polyurethane coatings, alone or mixed with the non-hydrophillically modified polyisocyanates described above. Hydrophilic properties can be imparted, e.g., anionically, cationically, or non-ionically by means of internal or external emulsifiers such as polyethers. Polyisocyanates of this type are described e.g. in EP-A 443 138, EP-A 469 389, EP-A 486 881, EP-A 510 438, EP-A 540 985, EP-A 645 410, EP-A 697 424, EP-A 728 785 and German patent application DE 19 822 891.0.

It is important that the silane component of formula (I) is inert to isocyanate groups, but is reactive with acid groups in the resin dispersions via its epoxy groups.

Examples of suitable epoxy-functional alkoxysilane compounds include (3-glycidoxypropyl)trimethoxysilane, (3-glycidoxypropyl)triethoxysilane, (3-glycidoxypropyl)triisopropoxysilane, β-(3,4-epoxycyclohexyl)ethyl-trimethoxysilane and β-(3,4-epoxycyclohexyl)ethyltriethoxysilane. The silanes having methoxy groups as the alkoxy groups, e.g. (3-glycidoxypropyl)trimethoxysilane and β-(3,4-epoxycyclohexyl)ethyltrimethoxysilane are particularly preferred.

The use of (3-glycidoxypropyl)trimethoxysilane is preferred.

Silane components of formula (I) are preferably used in concentrations of 0.2 to 3.0%, based on the sum of the solids content of the resin dispersion and of the polyisocyanate.

The molar ratio of the hydroxyl groups of component a) to the isocyanate groups of component b) is 0.2:1 to 3:1, preferably 0.5:1 to 2:1.

Crosslinking agent component b) has a viscosity of 5 to 10,000, preferably 5 to 2,000 mPa.s (with D=40 s⁻¹) at 23° C. If necessary, the polyisocyanates can be blended with small quantities of inert solvents in order to reduce the viscosity to a value within the above ranges. However, the maximum quantity of these solvents is such that no more than 20 wt. %, preferably no more than 10 wt. %, solvent is present in the final coating composition according to the invention, including in the calculation any solvent still present in resin dispersions a). Suitable solvents include aliphatic or aromatic hydrocarbons such as toluene, xylene, or solvent naphtha; and N-methylpyrrolidone, diethylene glycol dimethyl ether, dipropylene glycol dimethyl ether, butyl glycol, acetone, methyl ethyl ketone, methyl isobutyl ketone, ethyl acetate, n-butyl acetate, methoxypropyl acetate, methoxybutyl acetate and mixtures of these or other inert solvents.

To produce the aqueous coating composition, hardener component b) is emulsified in aqueous resin component a). Before adding component b), however, silane component c) is either emulsified in aqueous resin component a) or dissolved in hardener component b). The addition of silane component c) to polyisocyanate component b) before dispersing the mixture of b) and c) with aqueous, hydroxyl-containing resin dispersion a) is preferred. A premature reaction of silane component c) in aqueous resin dispersion a) is thereby avoided.

In order to increase the reactivity of silane component c) during application, it is possible to add titanium or organotin catalysts in accordance with U.S. Pat. No. 5,621,038. The reactivity of the isocyanate groups in the aqueous 2K PU system is also increased by these catalysts. It is therefore preferred to use these catalysts in a concentration of no more than 1.0 wt. %, based on the sum of the solids contents of components a)-c). Silane component c) is preferably applied without the use of catalysts.

Before the preferred addition of the mixture of hardener component b) blended with silane component c) to polymer component a), the known additives from paint technology may be incorporated in component a) or b) and c). Examples include defoamers, thickeners, flow promoters, pigments, dispersing agents and solvents. Water is used to adjust to the required working consistency.

In most cases simple emulsifying techniques e.g. with a mechanical stirrer or often simply mixing components a), b) and c) by hand, are sufficient to achieve coatings with very good properties. However, mixing techniques with higher shear energy can also be used, such as jet dispersion as described in Farbe & Lack 102/1, 1996, p. 88 to 100.

The coating compositions according to the invention are particularly suitable for untreated steel surfaces (aluminium, galvanized steel, car body steel sheet) as pigmented or unpigmented primers and fillers, e.g. in the industrial coating, and automotive finishing or refinishing sectors.

The coatings can be applied by many different spray processes, such as air pressure, airless or electrostatic spraying using one- or two-component spray equipment, and also by brush, roller or knife application.

The coating is generally dried and cured under ambient temperature conditions at 5 to 40° C., i.e., without heating the coating. However, the coating compositions according to the invention can also be used to produce coatings which are dried and cured at an elevated temperature of 40 to 150° C. after application.

The invention is further illustrated but is not intended to be limited by the following examples in which all parts and percentages are by weight unless otherwise specified.

### EXAMPLES

### Polyisocyanate 1

0.08 equivalents (eq.) of a monofunctional polyethylene oxide polyether initiated on methanol and having an average molecular weight of 350 was added at room temperature, with stirring, to 1.0 eq. of an isocyanurate group-containing polyisocyanate based on 1,6-diisocyanatohexane (HDI) and having an NCO content of 21.5%, an average NCO functionality of approx. 3.8 and a viscosity of 3000 mPa.s (23° C.) and then heated to 100° C. for 3 h.

After cooling to room temperature a practically colorless, clear polyisocyanate mixture was obtained. The NCO content was 17.3%, the content of ethylene oxide units was 11.3% and the viscosity was 3050 mPa.s (23° C).

### Polyisocyanate 2

(According to German patent application DE 19 822 891.0, U.S. Ser. No. 09/312,180)

850 g (4.39 eq.) of an isocyanurate group-containing polyisocyanate based on 1,6-diisocyanatohexane (HDI) having an NCO content of 21.7%, an average NCO functionality of 3.5 (by GPC), a monomeric HDI content of 0.1% and a viscosity of 3000 mPa.s (23° C.) were prepared at 100° C. under dry nitrogen with stirring. 150 g (0.30 eq.) of a monofunctional polyethylene oxide polyether initiated on methanol and having an average molecular weight of 500 (NCO/OH equivalent ratio of 14.6:1) were added within 30 min and stirring was then continued at this temperature until the NCO content of the mixture had fallen to a value of 17.2%, corresponding to complete urethanization, after about 2 h. The allophanatization reaction was initiated by adding 0.01 g zinc(II)-2-ethyl-1-hexanoate. This increased the temperature of the reaction mixture to 106° C. due to the heat of reaction. Once the exothermic reaction had subsided, about 30 min after adding the catalyst, the reaction was terminated by adding 0.01 g benzoyl chloride and the reaction mixture was cooled to room temperature. A practically colorless, clear polyisocyanate mixture was obtained having the following properties:

| | | |
|---|---|---|
| solids content: | 100% | |
| NCO content: | 16.0% | |
| NCO functionality: | 4.0 | |
| viscosity (23° C.) | 3200 | mPa · s |

### Polyisocyanate 3

(Desmodur N3600 Bayer AG)

An isocyanurate group-containing polyisocyanate based on 1,6-diisocyanatohexane and having an NCO content of 23.5%, an average NCO functionality of approx. 3.2 and a viscosity of 1200 mPa.s (23° C.).

### Polyisocyanate 4

(Bayhydur Trial Product LS 2150/1, Bayer AG)

An isocyanurate group-containing polyisocyanate, hydrophillically modified with polyether groups, based on 1-isocyanato-3,3,5-trimethyl-5-isocyanatomethylcyclohexane, dissolved to 70% in a mixture of methoxypropyl acetate and xylene (weight ratio 1:1), having an NCO content of 9.4% (based on solution), an average NCO functionality of approx. 3.0 and a viscosity of 700 mPa.s (23° C.).

### Polyacrylate 1 (Secondary Dispersion)

(Bayhydrol Trial Product LS 2235/1, Bayer AG

A polyacrylate according to EP-A 358 979 (U.S. Pat. No. 5,075,370) based on the following comonomers: 2-hydroxyethyl methacrylate, acrylic acid, methyl methacrylate and n-butyl acrylate, with a solids content of approx. 46%, an OH content of 3.3% based on resin solid, an acid value of approx. 21 mg KOH/g resin solid, a pH of 8.0 and a viscosity of approx. 800 mPa.s (23° C., D=40 s⁻¹ measured in a viscosimeter of Haake at a shear gradient of 40 s⁻¹); neutralizing agent: N-dimethylaminoethanol.

### Polyacrylate 2 (Primary Dispersion)

(Bayhydrol Trial Product LS 2250, Bayer AG)

A polyacrylate according to EP 358 979 (U.S. Pat. No. 5,075,370) based on the following comonomers: hydroxypropyl methacrylate, acrylic acid, methyl methacrylate and n-butyl acrylate, with a solids content of approx. 42%, an OH content of 2.0% based on resin solid, an acid value of approx. 28 mg KOH/g resin solid, a pH of 7.3 and a viscosity of approx. 300 mPa.s (23° C., D=40 s⁻¹); neutralizing agent: ammonia.

### Polyacrylate 3 (Primary Dispersion)

(Bayhydrol Trial Product LS 2318, Bayer AG)

A polyacrylate as in example 2, but with N-dimethylaminoethanol as neutralizing agent; solids content: 43.2%; acid value: approx. 28 mg KOH/g resin solid; pH 7.5; viscosity: approx. 400 mPa.s (23° C., D=40 s⁻¹).

### Polyurethane 1

Bayhydrol Trial Product LS 2917, Bayer AG)

An aqueous dispersion of a fatty acid-modified, hydrolytically stable polyurethane resin having a solids content of approx. 45%, an acid value of approx. 30 mg KOH/g resin solid, a pH value of approx. 7.0 and a viscosity of approx. 800 mPa.s (23° C., D=40 s⁻¹); neutralizing agent: triethylamine.

In application examples 1 a) to 4 b), the quantities are expressed in parts by weight. In each case, application tests were carried out with and without epoxysilane and compared with one another.

The components 1 and 2 listed in the following tables were mixed by hand very thoroughly for approx. 15 s using a wooden spatula.

TABLE 1
Formulation of aqueous 2K PU filler coating composition

| | | Example | | |
|---|---|---|---|---|
| | | 1 a) | 1 b) | Manufacturer |
| Component 1 | | | | |
| 1. | Polyacrylate 1 | 33.65 | 33.51 | |
| 2. | Surfynol 104 (wetting | 0.73 | 0.72 | Air Products N.L |
| | agent) 50% | | | |
| 3. | Borchigen SN 95 | 1.56 | 1.55 | Borchers, Monheim |
| | (dispersing agent), 25% | | | |
| 4. | Corrosion inhibitor L1, | 0.41 | 0.41 | C. H. Erbslöh, Krefeld |
| | 62% | | | |
| 5. | Omyacarb 1 T-AV | 25.09 | 24.98 | Omya GmbH, Cologne |
| | (filler: calcium | | | |
| | carbonate) | | | |
| 6. | Calcigloss (filler: | 5.38 | 5.36 | Omya GmbH, Cologne |
| | calcium carbonate) | | | |
| 7. | Talcum AT 1 (filler: talc) | 5.38 | 5.36 | Norwegian Talc, |
| | | | | Norway |
| 8. | Bayertitan R-KB-4 | 6.56 | 6.53 | Bayer AG |
| | (titanium dioxide) | | | |
| 9. | H₂O for Din 6 = 15 sec. | 10.54 | 10.50 | |

Component 2

| | | | | |
|---|---|---|---|---|
| 10. | Polyisocyanate 1 | 4.28 | 4.26 | |
| 11. | Polyisocyanate 3 | 4.28 | 4.26 | |
| 12. | Proglyde DMM | 2.14 | 2.13 | Dow Chemical |
| | (for 80% hardener | | | Corporation |
| | solution) | | | |
| 13. | Dynasilan GLYMO G | — | 0.43 | ABCR, Karlsruhe |
| | 6720¹⁾ | | | |
| | | 100.00 | 100.00 | |

| | | |
|---|---|---|
| NCO:OH | 1.5 | 1.5 |
| Solids (%) | 46 | 46 |
| Co-solvents (%) | 5.1 | 5.1 |
| VOC (g/l) | 150 | 150 |
| Density (kg/l) | 1.5 | 1.5 |
| pH value | 8.0 | 8.0 |
| Spraying viscosity Din 4(s) | 30 | 30 |

| | |
|---|---|
| Spraying dilution | deionized water |

¹⁾ = (3-glycidoxypropyl)trimethoxysilane (2% solid based on total resin solid)

TABLE 1a
Application examples

Example

| | 1 a) | 1 b) |
|---|---|---|
| 10 days condensation-constant atmosphere¹⁾ | | |
| DIN 50 017 | | |
| Blisters (DIN 53 209) | | |
| Primer: m/g² | 3/1 | 0/0 |
| Primer + topcoat: m/g | 5/1 | 0/0 |
| Crosshatch (DIN 53 151) | | |
| Primer: | 5 | 0 |
| Primer + topcoat: | 5 | 0 |
| 10 days salt spray test¹⁾ | | |
| DIN 53 167 | | |
| Blisters (DIN 53 209) | | |
| Primer: m/g | 2/1 | 0/0 |
| Primer + topcoat: m/g | 2/1 | 0/0 |
| Crosshatch (DIN 53 151) | | |
| (evaluation of adhesion) | | |
| Primer: | 3 | 0 |
| Primer + topcoat: | 3 | 0 |
| Creep corrosion | | |
| Evaluation on a scratch (DIN 53 167): mm | 1 | 1 |

¹⁾Preparation of test sheets:
Car body sheet (bright metallic), spray application of primers (60 μm dry film).
After 4 h/23° C. dry grinding of primer with P 400 grit.
Subsequent spray application of a 2K polyurethane topcoat (solvent-based) with 60 μm dry film.
After 7 d air drying (aging), corrosion resistance tests carried out.
²⁾m: amount of blisters;
m = 0 no blisters
m = 5 very many blisters per area unit
g: size of blisters;
g = 0 not visible
g = 5 very large

TABLE 2
Formulation of aqueous 2K PU filler coating compositions

| | | Example | | |
|---|---|---|---|---|
| | | 2 a) | 2 b) | Manufacturer |
| Component 1 | | | | |
| 1. | Polyacrylate 2 | 26.73 | 26.73 | |
| 2. | Polyurethane 1 | 8.14 | 8.14 | |
| 3. | NH3, 10% deionized | 0.08 | 0.08 | |
| | water (neutralizing agent) | | | |
| 4. | Surfynol 104 (wetting | 0.68 | 0.68 | Air Products N.L. |
| | agent) 50% | | | |
| 5. | Borchigen SN 95 | 1.42 | 1.42 | Borchers, Monheim |
| | (dispersing agent), 25% | | | |
| 6. | Corrosion inhibitor L1, | 0.23 | 0.23 | C. H. Erbslöh, Krefeld |
| | 62% | | | |
| 7. | Aerosil R 972 (thickener: | 1.78 | 1.78 | Degussa |
| | silica) | | | |
| 8. | Silica flour F 500 | 2.20 | 2.20 | Amberger |
| | (filler: silicon dioxide) | | | Kaolinwerke, Hirschau |
| 9. | China clay grade B | 6.76 | 6.76 | ECC International, |
| | (filler: aluminium | | | Düsseldorf |
| | silicate) | | | |
| 10. | Blanc fixe M | 8.85 | 8.85 | Sachtleben Chemie |
| | (filler: barium sulfate) | | | AG, Duisburg |
| 11. | Talcum AT 1 (filler: talc) | 5.52 | 5.52 | Norwegian Talc, |
| | | | | Norway |
| 12. | Bayertitan R-KB-4 | 6.17 | 6.17 | Bayer AG |
| | (titanium dioxide) | | | |
| 13. | Butyl glycol/water | 3.43 | 3.43 | Dow Chemical Corp. |
| | (cosolvents) | | | |
| 14. | deionized water for | 9.32 | 9.32 | |
| | dispersion | | | |
| 15. | deionized water for | 12.67 | 12.67 | |
| | Din 6 = 15 sec. | | | |

Component 2

| | | | | |
|---|---|---|---|---|
| 16. | Polyisocyanate 1 | 2.40 | 2.40 | |
| 17. | Polyisocyanate 4 | 3.43 | 3.43 | |
| 18. | Proglyde DMM | 0.18 | 0.18 | Dow Chemical Corp. |
| | (for 80% hardener | | | |
| | solution) | | | |
| 19. | Dynasilan GLYMO G | — | 0.39 | ABCR, Karlsruhe |
| | 6720¹⁾ | | | |
| | | 100.00 | 100.39 | |

| | | |
|---|---|---|
| NCO:OH | 1.0 | 1.0 |
| Solids (%) | 51.8 | 51.8 |
| Co-solvents (%) | 3.74 | 3.74 |
| VOC (g/l) | 101 | 101 |
| Density (kg/l) | 1.5 | 1.5 |
| pH value | 8.0 | 8.0 |
| Spraying viscosity Din 4(s) | 22 | 22 |

| | |
|---|---|
| Spraying dilution | deionized water |

¹⁾ = (3-glycidoxypropyl)trimethoxysilane (2% solid based on total resin solid)

TABLE 2a
Application examples

Example

| | 2 a) | 2 b) |
|---|---|---|
| 10 days condensation-constant atmosphere¹⁾ | | |
| DIN 50 017 | | |
| Blisters (DIN 53 209) | | |
| Primer: m/g | 5/1-2 | 1/1 |
| Primer + topcoat: m/g | 5/1-2 | 1/1 |
| Crosshatch (DIN 53 151) | | |
| Primer: | 2 | 0 |
| Primer + topcoat: | 2 | 0 |
| 10 days salt spray test¹⁾ | | |
| DIN 53 167 | | |
| Blisters (DIN 53 209) | | |
| Primer: m/g | 5/1-3 | 2/1 |
| Primer + topcoat: m/g | 5/1-3 | 2/1 |
| Crosshatch (DIN 53 151) | | |
| (evaluation of adhesion) | | |
| Primer: | 2 | 0 |
| Primer + topcoat: | 2 | 0 |
| Creep corrosion | | |
| Evaluation on a scratch (DIN 53 167): mm | 1 | 1 |

¹⁾Preparation of test sheets:
Car body sheet (bright metallic), spray application of primers (60 μm dry film).
After 4 h/23° C. dry grinding of primer with P 400 grit.
Subsequent spray application of a 2K polyurethane topcoat (solvent-based) with 60 μm dry film.
After 7 d air drying (aging), corrosion resistance tests carried out.

TABLE 3
Formulation of aqueous 2K PU filler coating compositions

| | | Example | | |
|---|---|---|---|---|
| | | 3 a) | 3 b) | Manufacture |
| Component 1 | | | | |
| 1. | Polyacrylate 3 | 34.87 | 34.87 | |
| 2. | Surfynol 104 (wetting | 0.68 | 0.68 | Air Products N.L. |
| | agent) 50% | | | |
| 3. | Borchigen SN 95 | 1.42 | 1.42 | Borchers, Monheim |
| | (dispersing agent), 25% | | | |
| 4. | Corrosion inhibitor L1, | 0.23 | 0.23 | C. H. Erbslöh, Krefeld |
| | 62% | | | |
| 5. | Aerosil R 972 (thickener: | 1.78 | 1.78 | Degussa |
| | silica) | | | |
| 6. | Silica flour F 500 | 2.20 | 2.20 | Amberger |
| | (filler: silicon dioxide) | | | Kaolinwerke Hirschau |
| 7. | China clay grade B | 6.76 | 6.76 | ECC International, |
| | (filler: aluminium | | | Düsseldorf |
| | silicate) | | | |
| 8. | Blanc fixe M (filler: | 8.85 | 8.85 | Sachtleben Chemie |
| | barium sulfate) | | | AG, Duisburg |
| 9. | Talcum AT 1 (filler: talc) | 5.52 | 5.52 | Norwegian Talc, |
| | | | | Norway |
| 10. | Bayertitan R-KB-4 | 6.17 | 6.17 | Bayer AG |
| | (titanium dioxide) | | | |
| 11. | Butyl glycol/water | 3.43 | 3.43 | Dow Chemicals Corp. |
| | (cosolvents) | | | |
| 12. | Deionized water for | 9.32 | 9.02 | |
| | dispersion | | | |
| 15. | Deionized water for | 12.69 | 12.6 | |
| | Din 6 = 15 sec. | | | |

Component 2

| | | | | |
|---|---|---|---|---|
| 14. | Polyisocyanate 1 | 2.43 | 2.43 | |
| 15. | Polyisocyanate 4 | 3.47 | 3.47 | |
| 16. | Proglyde DMM | 0.18 | 0.18 | Dow Chemicals Corp |
| | (for 80% hardener | | | |
| | solution) | | | |
| 19. | Dynasilan GLYMO G | — | 0.39 | ABCR, Karlsruhe |
| | 6720¹⁾ | | | |
| | | 100.00 | 100.00 | |

| | | |
|---|---|---|
| NCO:OH | 1.0 | 1.0 |
| Solids (%) | 51.8 | 51.8 |
| Co-solvents (%) | 3.74 | 3.74 |
| VOC (g/l) | 101 | 101 |
| Density (kg/l) | 1.5 | 1.5 |
| pH value | 8.0 | 8.0 |
| Spraying viscosity Din 4(s) | 22 | 22 |

| | |
|---|---|
| Spraying dilution | deionized water |

¹⁾ = (3-glycidoxypropyl)trimethoxysilane (2% solid based on total resin solid)

TABLE 3a
Application examples

Example

| | 3 a) | 3 b) |
|---|---|---|
| 10 days condensation-constant atmosphere¹⁾ | | |
| DIN 50 017 | | |
| Blisters (DIN 53 209) | | |
| Primer: m/g | 5/3 | 0/0 |
| Primer + topcoat: m/g | 5/3 | 0/0 |
| Crosshatch (DIN 53 151) | | |
| Primer: | 5 | 1 |
| Primer + topcoat: | 2 | 0 |
| 10 days salt spray test¹⁾ | | |
| DIN 53 167 | | |
| Blisters (DIN 53 209) | | |
| Primer: m/g | 5/3 | 3/1 |
| Primer + topcoat: m/g | 5/3 | 1/1-2 |
| Crosshatch (DIN 53 151) | | |
| (evaluation of adhesion) | | |
| Primer: | 5 | 1 |
| Primer + topcoat: | 2 | 0 |
| Creep corrosion | | |
| Evaluation on a scratch (DIN 53 167): mm | 1 | 1 |

¹⁾Preparation of test sheets:
Car body sheet (bright metallic), spray application of primers (60 μm dry film).
After 4 h/23° C. dry grinding of primer with P 400 grit.
Subsequent spray application of a 2K polyurethane topcoat (solvent-based) with 60 μm dry film.
After 7 d air drying (aging), corrosion resistance tests carried out.

TABLE 4
Formulation of aqueous 2K PU filler coating compositions

| | | Example | | |
|---|---|---|---|---|
| | | 4 a) | 4 b) | Manufacturer |
| Component 1 | | | | |
| 1. | Polyacrylate 3 | 34.0 | 34.0 | |
| 2. | Surfynol 104 (wetting | 0.66 | 0.66 | Air Products N.L. |
| | agent) 50% | | | |
| 3. | Borchigen SN 95 | 1.38 | 1.38 | Borchers, Monheim |
| | (dispersing agent), 25% | | | |
| 4. | Corrosion inhibitor L1, | 0.22 | 0.22 | C. H. Erbslöh, Krefeld |
| | 62% | | | |
| 5. | Aerosil R 972 (thickener: | 1.74 | 1.74 | Degussa |
| | silica) | | | |
| 6. | Silica flour F 500 (filler: | 2.15 | 2.15 | Amberger |
| | silicon dioxide) | | | Kaolinwerke, Hirschau |
| 7. | China clay grade B | 6.59 | 6.59 | ECC International, |
| | (filler: aluminium | | | Düsseldorf |
| | silicate) | | | |
| 8. | Blanc fixe M (filler: | 8.63 | 8.63 | Sachtleben Chemie |
| | barium sulfate) | | | AG, Duisburg |
| 9. | Talcum AT 1 (filler: talc) | 5.38 | 5.38 | Norwegian Talc, |
| | | | | Norway |
| 10. | Bayertitan R-KB-4 | 6.02 | 6.02 | Bayer AG |
| | (titanium dioxide) | | | |
| 11. | Butyl glycol/water | 3.34 | 3.34 | Dow Chemicals Corp. |
| | (co-solvents) | | | |
| 12. | Deionized water for | 9.09 | 8.89 | |
| | dispersion | | | |
| 13. | Deionized water for | 12.30 | 12.08 | |
| | Din 6 = 15 sec. | | | |

Component 2

| | | | | |
|---|---|---|---|---|
| 14. | Polyisocyanate 2 | 6.80 | 6.80 | |
| 15. | Proglyde DMM | 1.70 | 1.70 | Dow Chemicals Corp. |
| | (for 80% hardener | | | |
| | solution) | | | |
| 16. | Dynasilan GLYMO G | — | 0.42 | ABCR, Karlsruhe |
| | 6720¹⁾ | | | |
| | | 100.00 | 100.00 | |

| | | |
|---|---|---|
| NCO:OH | 1.5 | 1.5 |
| Solids (%) | 52.9 | 52.9 |
| Co-solvents (%) | 3.7 | 3.7 |
| VOC (g/l) | 98 | 98 |
| Density (kg/l) | 1.5 | 1.5 |
| pH value | 8.0 | 8.0 |
| Spraying viscosity Din 4(s) | 22 | 22 |

| | |
|---|---|
| Spraying dilution | deionized water |

¹⁾ = (3-glycidoxypropyl)trimethoxysilane (2% solid based on total resin solid)

TABLE 4a
Application examples

Example

| | 4 a) | 4 b) |
|---|---|---|
| 10 days condensation-constant atmosphere¹⁾ | | |
| DIN 50 017 | | |
| Blisters (DIN 53 209) | | |
| Primer: m/g | 5/3 | 0/0 |
| Primer + topcoat: m/g | 5/3 | 1/1 |
| Crosshatch (DIN 53 151) | | |
| Primer: | 5 | 0 |
| Primer + topcoat: | 2 | 0 |
| 10 days salt spray test¹⁾ | | |
| DIN 53 167 | | |
| Blisters (DIN 53 209) | | |
| Primer: m/g | 5/3 | 2/1 |
| Primer + topcoat: m/g | 5/3 | 1/1-2 |
| Crosshatch (DIN 53 151) | | |
| (evaluation of adhesion) | | |
| Primer: | 5 | 1 |
| Primer + topcoat: | 3 | 0 |
| Creep corrosion | | |
| Evaluation on a scratch (DIN 53 167): mm | 1 | 1 |

¹⁾Preparation of test sheets:
Car body sheet (bright metallic), spray application of primers (60 μm dry film).
After 4 h/23° C. dry grinding of primer with P 400 grit.
Subsequent spray application of a 2K polyurethane topcoat (solvent-based) with 60 μm dry film.
After 7 d air drying (aging), corrosion resistance tests carried out.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A coating composition comprising
a) 30 to 95 wt. % of an aqueous, hydroxy-functional resin dispersion,
b) 5 to 70 wt. % of a polyisocyanate component having a free isocyanate group content of 5 to 50 wt. % and a viscosity of 5 to 10,000 mPa.s (at 23° C. and D=40 s⁻¹) and
c) 0.1 to 10 wt. % of a silane component of the general formula (I) 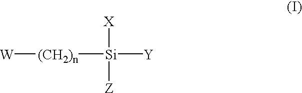
wherein
W denotes the groups 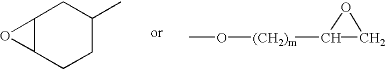
(with m=1 to 4) and
n denotes a whole number from 2-4 and
X, Y, Z represent, independently of one another, the same or different organic groups with 1 to 30 C atoms, with the proviso that at least one of the groups represents an alkoxy group with 1 to 4 carbon atoms,
wherein the molar ratio of the hydroxyl groups of component a) to the isocyanate groups of component b) is between 0.2:1 and 3:1, and the sum of the wt. % of components a) to c) is 100.

2. The coating composition according to claim 1, wherein
W represents the group 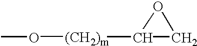
n is 3 and
X, Y, Z represent, independently of one another, methoxy or ethoxy groups.

3. The coating composition according to claim 1, wherein the silane component c) comprises (3-glycidoxypropyl)trimethoxysilane.

4. The coating composition according to claim 1, wherein
W denotes the group 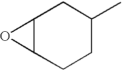
n denotes 2 and
X, Y, Z represent, independently of one another, methoxy or ethoxy groups.

5. A coated substrate coated with a coating composition according to claim 1.

6. A method of coating a substrate comprising coating a metallic substrate with the coating composition according to claim 1.

7. A method of producing the coating composition according to claim 1, comprising the step of adding the silane component c) to the polyisocyanate component b) before dispersing the mixture of b) and c) with the aqueous, hydroxyl-containing resin dispersion a).
